(19) United States
(12) Patent Application Publication
(10) Pub. No.: US 2025/0029035 A1
(43) Pub. Date: Jan. 23, 2025

(54) AUTOMATED ACQUISTION OF INFORMATION HANDLING SYSTEM HARDWARE COMPONENTS TO ACHIEVE OPTIMIZED USER WORKSPACE PERFORMANCE TOGETHER WITH IMPROVED SUSTAINABILITY

(71) Applicant: DELL PRODUCTS L.P., ROUND ROCK, TX (US)

(72) Inventors: Fnu Jasleen, Austin, TX (US); Gandali Patil, San Antonio, TX (US)

(21) Appl. No.: 18/224,522

(22) Filed: Jul. 20, 2023

(51) Int. Cl. G06Q 10/0631; G06Q 10/0637

(52) U.S. Cl. CPC G06Q 10/06315; G06Q 10/06375

(57) ABSTRACT

Systems and methods are provided that may be implemented on an information handling system to select and acquire available information system hardware components in an automated manner that improves user workspace performance, achieves improved system sustainability, and reduces the carbon footprint of the user's information handling system. The available information system hardware components may be selected and acquired based on a single hardware component acquisition score that is generated for a given user of an information handling system based on a combination of inward data (e.g., including factors such as system workspace characteristics and usage patterns of the given user) and outward data of available (e.g., new) system hardware components (e.g., including factors such as environmental sustainability of component hardware and hardware component manufacturing characteristics).

### FIELD

This application relates to information handling systems and, more particularly, to acquisition and replacement of information hardware components.

### BACKGROUND

As the value and use of information continues to increase, individuals and businesses seek additional ways to process and store information. One option available to human users is information handling systems. An information handling system generally processes, compiles, stores, and/or communicates information or data for business, personal, or other purposes thereby allowing human users to take advantage of the value of the information. Because technology and information handling needs and requirements vary between different human users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific human user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Together with information handling system performance, device sustainability and carbon footprint are important considerations when acquiring or replacing information handling system hardware components. As companies move towards carbon-neutral goals, information technology decision makers (ITDMs) have an increased focus on acquiring sustainable hardware components for their users and fleet of devices. When attempting to acquire or replace information handling system hardware components for a user, it is difficult for an ITDM to identify and acquire system hardware components that are both tailored to the user's computing needs and that are sustainable and environmentally friendly. Acquiring and/or placing into operation standard types of hardware components for all users administered by an ITDM results in providing hardware resources having computing performance that is insufficient for the computing needs of some individual users and that exceeds the computing needs of other individual users. This results in placement of systems that are ill-matched for many users' needs, leading to user dissatisfaction with computing performance, wasted money for overdesigned systems, and a needlessly higher system carbon footprint or otherwise having a system sustainability that is not optimal for the user.

Currently users and ITDMs must manually identify and acquire new information handling system hardware based on manual analysis of conventionally available data which is incomplete and misleading concerning new information handling system hardware environmental characteristics such as sustainability (e.g., carbon footprint), and which makes it hard or impossible for users and ITDMs to manually identify a new configuration of information handling system hardware that meets the personalized needs of a given user. This conventionally available information is provided in a form that is not sufficient to allow users and ITDMs to evaluate new information handling system hardware environmental characteristics in a useful manner that allows a user or ITDM to make an informed decision on what hardware components to purchase.

Manufacturers of information handling system hardware components make calculations and publish data related to environmental characteristics of their systems. However, this available environmental characteristic data is not prepared consistently by different manufacturers, and different types of environmental characteristics are typically not presented together in a single comprehensive document or other data source by a given manufacturer for its various information handling system hardware components. Rather, manufacturers typically spread data out regarding these environmental characteristics among multiple different documents or data sources. This makes it difficult or impossible for a user or ITDM to find, read and understand the complete data regarding the environmental characteristics of a given information handling system hardware component so that a proper informed decision can be made regarding purchase of new information handling system hardware components. Moreover, the conventionally available manufacturer environmental characteristic data often claims that each given information handling system hardware component is energy efficient or otherwise sustainable (low carbon footprint or used sustainable products during manufacturing) from a different perspective which leaves the user or ITDM confused when manually comparing efficiency and sustainability of multiple different information handling system hardware component options to each other.

### SUMMARY

Disclosed herein are systems and methods that may be implemented to select and acquire new information system hardware components in an automated manner that improves user workspace performance, achieves improved system sustainability, and reduces the carbon footprint of the user's information handling system. The disclosed systems and methods may be implemented in one embodiment to generate a single hardware component acquisition score for a given user of an information handling system based on a combination of inward data (e.g., including data factors such as system workspace characteristics and usage patterns of the given user) and outward data of available (e.g., new) system hardware components (e.g., including data factors such as environmental sustainability of component hardware and hardware component manufacturing characteristics). In one embodiment, the disclosed systems and methods may be implemented using unsupervised Machine Learning (e.g., such as a Bayesian Shrinkage Method) after combining inward and outward data factors to assign weights to individual data factors of the combination to create a relevance prioritization that is unique for each given user.

The disclosed systems and methods may be implemented in one embodiment to automatically identify and acquire an optimum configuration of new or replacement information handling system hardware components (e.g., one or more hardware components for use with an information handling system or an entire information handling system itself) for a given user based on a combination of data factors including inward data factors of the given user's past information handling system workspace configuration and usage trends, and outward data factors of information handling system hardware components that are available for acquisition for the given user. In this way, the disclosed systems and methods may be implemented to improve information handling system environmental characteristics (e.g., by decreasing system operating energy use, reducing system carbon footprint and increasing system sustainability, etc.), while at the same time improving user workspace performance (e.g., by reducing graphics and computing latency for a given user's needs, etc.). In this way, the disclosed systems and methods may be implemented in one embodiment understanding a given user's workspace and making personalized component selection and acquisition for the given user by understanding the user to improve user experience.

In one embodiment, the disclosed systems and methods may be implemented to detect and capture inward user usage data on how a given user utilizes existing information handling system hardware components (e.g., including core information handling system hardware components and peripheral information handling system hardware components) and to combine this inward user usage data with outward (e.g., sustainability) data to automatically identify (e.g., select) and acquire new information handling system hardware components that are selected to meet the user's needs and also to achieve optimum sustainability (e.g., including a reduced carbon footprint) for the given user's information handling system.

In one embodiment, outward data may be automatically obtained from available information handling system hardware components based on environmental characteristics (data factors) of these available information handling system hardware components including, but not limited to, the carbon emission footprint, transportation, water usage, resource depletion and energy inputs of the manufacturing process and products used to manufacture these available information handling system hardware components, as well as the operating energy efficiency, end-of-life in operation, human toxicity, ecotoxicity, of these available information handling system hardware components when placed in use, etc.

In one embodiment, the disclosed systems and methods may be used by a given individual user to acquire a personalized optimum configuration of new information handling system hardware components that has the lowest carbon footprint, best operating energy efficiency, and greatest sustainability that also meets the usage requirement of the given user. In another embodiment, the disclosed systems and methods may be used by information technology decision makers (ITDMs) to acquire new information handling system hardware for multiple users that are personalized to fit each individual user's requirements in a manner that achieves the lowest carbon footprint, best energy efficiency, and greatest sustainability for each user.

The disclosed systems and methods may be advantageously implemented to automatically acquire the optimum configuration of new information handling system hardware components in a manner that is not conventionally possible by users and ITDMs who must rely on manual analysis of conventionally available data which is incomplete and misleading concerning new information handling system hardware environmental characteristics (e.g., sustainability, carbon footprint, operating energy usage, etc.). Unlike the disclosed systems and methods, this conventionally available data makes it hard or impossible for users and ITDMs to manually identify a new configuration of information handling system hardware that meets the personalized needs a given user. Moreover, the disclosed systems and methods may be implemented to acquire new information handling system hardware components based on an individual user's previous system usage data, and in a manner that is unlike the conventional case in which an individual user's previous system usage data is not taken into consideration by an individual user or an ITDM and which leads the individual user or ITDM to purchase products that do not have the right system workspace performance fit for a given user and that have undesirable environmental characteristics such as a needlessly high carbon footprint, reduced sustainability, excessive operating energy consumption, etc.

In one respect, disclosed herein is a method, including executing at least one programmable integrated circuit to: obtain one or more inward data factors that include at least one of workspace configuration or one or more usage patterns for a given user of a local information handling system, obtain one or more outward data factors for each of multiple different available information handling system hardware component types that are different from the local information handling system, the one or more outward data factors including at least one of device or system life cycle data, manufacturer report/s, or manufacturer certification/s for each of the multiple different available information handling system hardware component types, combine the inward data factors with the outward data factors of each of the multiple different available information handling system hardware component types to determine a hardware component acquisition score for each of the multiple different available information handling system hardware component types, compare the hardware component acquisition scores of the multiple different available information handling system hardware component types to each other, and select a given one of the multiple different available information handling system hardware component types that has the highest hardware component acquisition score relative to all other of the multiple different available information handling system types. The method may also include acquiring the selected given one of the multiple different available information handling system hardware component types for the given user of the local information handling system by physically transferring the selected given one of the multiple different available information handling system hardware component types to the given user of the local information handling system.

In another respect, disclosed herein is an information handling system, including at least one programmable integrated circuit that is programmed to: obtain one or more inward data factors that include at least one of workspace configuration or one or more usage patterns for a given user of a local information handling system; obtain one or more outward data factors for each of multiple different available information handling system hardware component types that are different from the local information handling system, the one or more outward data factors including at least one of device or system life cycle data, manufacturer report/s, or manufacturer certification/s for each of the multiple different available information handling system hardware component types; combine the inward data factors with the outward data factors of each of the multiple different available information handling system hardware component types to determine a hardware component acquisition score for each of the multiple different available information handling system hardware component types; compare the hardware component acquisition scores of the multiple different available information handling system hardware component types to each other; select a given one of the multiple different available information handling system hardware component types that has the highest hardware component acquisition score relative to all other of the multiple different available information handling system types; and acquire the selected given one of the multiple different available information handling system hardware component types for the given user of the local information handling system by requesting physical transfer of the selected given one of the multiple different available information handling system hardware component types to the given user of the local information handling system.

### BRIEF DESCRIPTION OF THE DRAWINGS

FIG. 1 illustrates a block diagram of a network environment according to one exemplary embodiment of the disclosed systems and methods.

FIG. 2 illustrates example inward data factors according to one exemplary embodiment of the disclosed systems and methods.

FIG. 3 illustrates methodology according to one exemplary embodiment of the disclosed systems and methods.

FIG. 4 illustrates methodology according to one exemplary embodiment of the disclosed systems and methods.

FIG. 5 illustrates a hypothetical Gaussian plot according to one exemplary embodiment of the disclosed systems and methods.

FIG. 6 illustrates methodology according to one exemplary embodiment of the disclosed systems and methods.

### DESCRIPTION OF ILLUSTRATIVE EMBODIMENTS

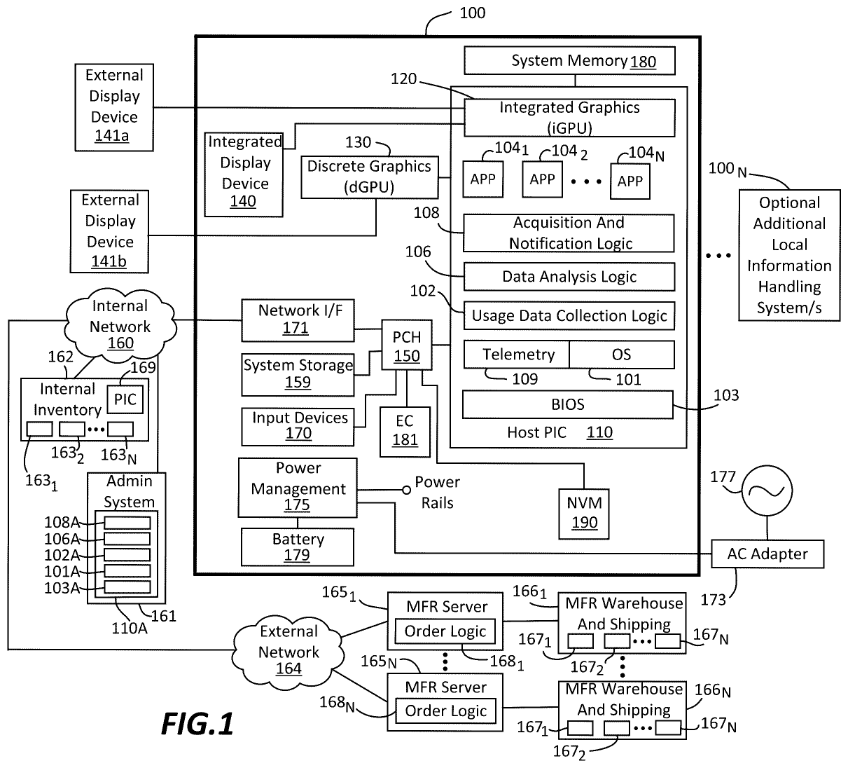

FIG. 1 is a block diagram of one embodiment of a network environment including an existing battery-powered local user information handling system 100 (e.g., battery powered notebook, laptop or tablet computer) that is operated by (e.g., assigned to or owned by) a given human user. In this regard, it should be understood that the configuration of FIG. 1 is exemplary only, and that the disclosed methods may be implemented on other types of information handling systems (e.g., desktop computer, tower computer, all-in-one computer, etc.). It should be further understood that while certain components of an information handling system are shown in FIG. 1 for illustrating embodiments of the disclosed systems and methods, an information handling system implementing the disclosed systems and methods is not restricted to including only those components shown in FIG. 1 and described below. Rather, an information handling system implementing the disclosed systems and methods may include additional, fewer or alternative components.

In the embodiment of FIG. 1, local user information handling system 100 may include a chassis enclosure (e.g., a plastic and/or metal housing) that encloses internal integrated components of local user information handling system 100. In this embodiment, local user information handling system 100 includes a host programmable integrated circuit (PIC) 110, e.g., such as an Intel central processing unit (CPU), an Advanced Micro Devices (AMD) CPU or another type of host programmable integrated circuit. In the embodiment of FIG. 1, host programmable integrated circuit 110 executes logic or code that includes a system basic input/output system (BIOS) 103, a host operating system (OS) 101 (e.g., proprietary OS such as Microsoft Windows 10, open source OS such as Linux OS, etc.), a usage data collection logic 102 that obtains telemetry from OS 101 via plug-ins and/or one or more telemetry utilities 109, data analysis logic 106, and acquisition and notification logic 108. Also executing on host programmable integrated circuit 110 may be one or more user applications 104₁ to 104_{N} (e.g., email application, calendar application, web conference application, computer game application, note-taking application, photo editing application, weather simulator application or other type of simulation application, message application, word processing application, Internet browser, PDF viewer, spreadsheet application, etc.).

In the illustrated embodiment, host programmable integrated circuit 110 may be coupled as shown to an internal (integrated) display device 140 and/or a peripheral external display device 141a, each of which may be a LCD or LED display, touchscreen or other suitable display device having a display screen for displaying visual images to a user. In this embodiment, integrated graphics capability may be implemented by host programmable integrated circuit 110 using an integrated graphics processing unit (iGPU) 120 to provide visual images (e.g., a graphical user interface, static images and/or video content, etc.) to internal display device 140 and/or to external display device 141a for display to a user of local user information handling system 100. Also in this embodiment, an internal discrete graphics processing unit (dGPU) 130 may be coupled as shown between host programmable integrated circuit 110 and peripheral external display device 141b which has a display screen for displaying visual images to the user, and dGPU 130 may provide visual images (e.g., a graphical user interface, static images and/or video content, etc.) to external display device 141b for display to the user of local user information handling system 100.

In some embodiments, dGPU 130 may additionally or alternatively be coupled to provide visual images (e.g., a graphical user interface, static images and/or video content, etc.) to internal display device 140 and/or to external display device 141a for display to a user of local user information handling system 100. In some embodiments, a graphics source for internal display device 140, external display device 141a and/or 141b may be switchable between iGPU 120, dGPU 130 and an eGPU when the latter is present. In other embodiments, an external GPU (xGPU) may additionally or alternatively be coupled between host programmable integrated circuit 110 and an external display device such as external display device 141a, 141b or another peripheral external display device. Further information on different configurations, operation and switching of iGPUs, dGPUs and xGPUs may be found, for example, in U.S. Pat. No. 9,558,527 which is incorporated herein by reference in its entirety for all purposes.

As further shown in FIG. 1, host programmable integrated circuit 110 may be coupled to volatile system memory 180, which may include, for example, random access memory (RAM), dynamic RAM (DRAM), synchronous DRAM (SDRAM). Host programmable integrated circuit 110 may also be coupled to access non-volatile memory 190 (e.g., such as serial peripheral interface (SPI) Flash memory) for purposes such as to load and boot system basic input/output system (BIOS) 103 that is stored thereon, etc.

In FIG. 1, PCH 150 controls certain data paths and manages information flow between components of the local user information handling system 100. As such, PCH 150 may include one or more integrated controllers or interfaces for controlling the data paths connecting PCH 150 with host programmable integrated circuit 110, local system storage 159, input devices 170 forming at least a part of a user interface for the information handling system, network interface (I/F) device 171, embedded controller (EC) 181, and NVM 190, e.g., where BIOS firmware image and settings may be stored together with other components including ACPI firmware, etc. In one embodiment, PCH 150 may include a Serial Peripheral Interface (SPI) controller and an Enhanced Serial Peripheral Interface (eSPI) controller. In some embodiments, PCH 150 may include one or more additional integrated controllers or interfaces such as, but not limited to, a Peripheral Controller Interconnect (PCI) controller, a PCI-Express (PCIe) controller, a low pin count (LPC) controller, a Small Computer Serial Interface (SCSI), an Industry Standard Architecture (ISA) interface, an Inter-Integrated Circuit (I²C) interface, a Universal Serial Bus (USB) interface and a Thunderbolt™ interface.

In the embodiment of FIG. 1, external (peripheral) and/or internal (integrated) input devices 170 (e.g., a keyboard, mouse, touchpad, touchscreen, etc.) may be coupled to PCH 150 of system 100 to enable the system end user to input data and interact with local user information handling system 100, and to interact with user applications or other software/firmware logic executing thereon. Local system storage 159 (e.g., one or more media drives, such as hard disk drives, optical drives, NVRAM, Flash memory, solid state drives (SSDs), or any other suitable form of internal or external storage) is coupled through PCH 150 to provide non-volatile storage for local user information handling system 100.

In the embodiment of FIG. 1, the network I/F device 171 enables wired and/or wireless communication via an internal network 160 (e.g., a corporate intranet) with an administrator information handling system (e.g., administrative server) 161 that in one embodiment may be configured with the same or similar hardware and/or software components as local information handling system 100 (e.g., including a host programmable integrated circuit 110A, BIOS 103A, host OS 101A, usage data collection logic 102A, data analysis logic 106A, one or more telemetry utilities 109A, acquisition and notification logic 108A, etc.). In this embodiment, network I/F device 171 also enables wired and/or wireless communication via internal network 160 and an external network 164 (e.g., the Internet) with remote information handling systems (e.g., remote manufacturer servers 165₁ to 165_{N} that are each maintained by respective different manufacturers of information handling system hardware components) that in one embodiment may each be configured with a programmable integrated circuit that executes system order logic 168 as well as the same or similar types of hardware components as local information handling system 100.

As further illustrated in FIG. 1, one or more additional and local information handling systems 100_{N} (e.g., each operated by a different given human user) may optionally also be coupled to internal network 160 to form a fleet of multiple local information handling systems that are administered by an ITDM that operates administrative information handling system 161. In such an optional embodiment, each of these one or more additional multiple local information handling systems 100_{N} may be configured with the same or similar hardware and/or software components as local information handling system 100 (e.g., including a host programmable integrated circuit 110, BIOS 103, host OS 101, usage data collection logic 102, data analysis logic 106, one or more telemetry utilities 109, acquisition and notification logic 108, etc.)

In one embodiment, network I/F device 171 may be a network interface controller (NIC) which may optionally communicate with the internal network 160 and external network 164 across an intervening local area network (LAN), wireless LAN (WLAN), cellular network, etc. In other embodiments, user information handling system 100 may be a stand-alone local user system that is coupled directly to external network 164 without the presence of intervening internal network 160, i.e., so that user information handling system may communicate directly with remote information handling systems (e.g., manufacturer servers 165₁ to 165_{N}) and without the presence of administrative information handling system 161.

As shown in FIG. 1, each of manufacturer servers 165₁ to 165_{N} is coupled to a respective manufacturer warehouse and shipping facility 166 that contains an existing manufacturer inventory of multiple different types (e.g., different model numbers) of different categories of available information handling system hardware components 167₁ to 167_{N} (e.g., different types of programmable integrated circuits, storage devices, memory devices, batteries, peripheral components, etc.; and/or different types of assembled information handling systems having different respective system configurations of programmable integrated circuits, storage devices, memory devices, batteries, peripheral components, etc.) that have been manufactured by a different respective manufacturer. Although described in this example embodiment as manufacturer servers 165 and manufacturer warehouse and shipping facilities 166, it will be understood that in other embodiments that the disclosed systems and methods may be similarly implemented using other types of servers and/or warehouse and shipping facilities, e.g., such as supplier servers and/or supplier warehouse and shipping facilities, etc.

Also shown in FIG. 1 is internal system inventory 162 that is maintained by a programmable integrated circuit (PIC) 169 of internal system inventory 162 that is coupled to administrative system 161 by internal network 160. In this embodiment, internal system inventory 162 includes an existing inventory (e.g., contained in one or more internal warehouses) containing multiple different types of available information handling system hardware components 163₁ to 163_{N} (e.g., different types of programmable integrated circuits, storage devices, memory devices, batteries, peripheral components, etc.; and/or different types of assembled information handling systems having different respective system configurations of programmable integrated circuits, storage devices, memory devices, batteries, peripheral components, etc.) that have been previously obtained from one or more different information handling system component manufacturers.

Thus, types of available information handling system hardware components 167 and 163 may include individual types of internal or core information handling system hardware components (e.g., such as programmable integrated circuits, storage drives, memory devices, batteries etc.), information handling system peripheral components (e.g., such as external keyboard devices, external mouse devices, external display devices, etc.), and/or types of entire or complete assembled information handling systems (e.g., such as a notebook computers, tablet computers, desktop computers, all-in-one computers, etc.).

In the illustrated embodiment of FIG. 1, a power source for the local user information handling system 100 may be provided by an external power source (e.g., mains power 177 and an AC adapter 173) and/or by an optional internal power source, such as a battery 179. As shown in FIG. 1, power management system 175 may be included within local user information handling system 100 for moderating and switching the available power from the power source/s. In one embodiment, power management system 175 may be coupled to provide operating voltages on one or more power rails to one or more components of the local user information handling system 100, as well as to perform other power-related administrative tasks of the information handling system.

In the embodiment of FIG. 1, embedded controller (EC) 181 is coupled to PCH 150 and may be configured to perform functions such as power and thermal system management, etc. EC 181 may also be configured to execute program instructions to boot local user information handling system 100, load application firmware from NVM 190 into internal memory, launch the application firmware, etc. In one example, EC 181 may include a microcontroller or other programmable integrated circuit for executing program instructions to perform the above-stated functions.

In the embodiment of FIG. 1, data analysis logic 106 executing on host programmable integrated circuit 110 is programmed to create a single hardware component acquisition score based on a combination of inward data and outward data for each of multiple different available information handling system hardware components that may be potentially acquired for the given user of local information handling system 100 from internal system inventory 162 and/or manufacturer inventories maintained in manufacturer warehouse and shipping facilities 166. This hardware component acquisition score may be created by data analysis logic 106 to reflect, among other things, inward (e.g., usage) data for the given user and outward (e.g., environmental sustainability) data for each different available information handling system hardware component, and may be used to determine which one or more of the different available information handling system hardware components to acquire for the given user of local information handling system 100.

In one embodiment, the hardware component acquisition score determined by data analysis logic 106 may be based on a combination of inward data (e.g., inward data factors determined by data analysis logic 106 based on a given user's system usage data such as the given user's previous user workspace and user usage patterns on some or all devices/peripherals of local information handling system 100) and outward data that includes data factors such as carbon emission footprint, water usage, transportation, water usage, use of recycled materials, resource depletion and energy inputs of the manufacturing process and products used to manufacture these available information handling system hardware components, as well as the operating energy efficiency, system end-of-life once placed in operation, human toxicity, ecotoxicity, of these available information handling system hardware components when placed in use, etc.). In one embodiment, inward data factors from the inward data may be combined with outward data factors from the outward data by data analysis logic 106 to determine a single personalized hardware component acquisition score for the given user of local information handling system 100.

In one embodiment, using a hardware component acquisition score based on a combination of inward data and outward data for different types of available information handling system hardware components is superior for selecting and acquiring a new information handling system component as compared to selecting and acquiring a new information handling system component based only on sustainability data for different available information handling system hardware components. This is because actual life of an information handling system component once placed into field operation is based on a user's workspace and usage patterns. For example, a first user employing a relatively simple workspace setup (e.g., using no peripheral devices or a relatively smaller number of peripheral devices in their workspace) on a laptop that always works on DC power will have a greatest hardware component acquisition score for a battery-optimized laptop information handling system, while a second and different user employing a relatively complex workplace setup (e.g., using a relatively larger number of multiple peripheral devices in their workspace than the first user) will have a greatest hardware component acquisition score for a laptop information handling system with more ports and higher computing resource capability.

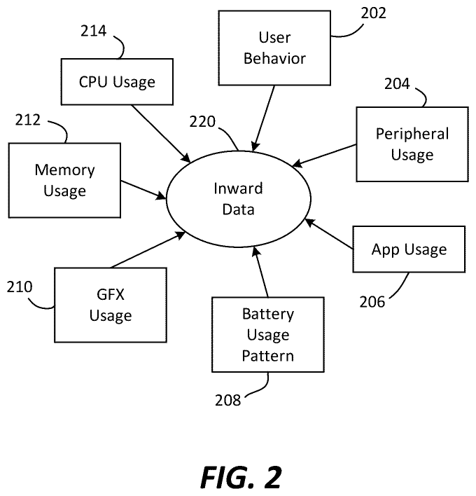

FIG. 2 illustrates example inward data factors that may be gathered (e.g., monitored) and analyzed by data analysis logic 106 as inward data 220 for a current existing local information handling system 100 that is operated by a given user. In FIG. 2, these example inward data factors include user behavior 202, peripheral usage 204, user application usage 206, battery usage pattern 208, graphics (GFX) resource usage 210, system memory usage 212, and host programmable integrated circuit (e.g., CPU) resource usage 214. It will be understood that the example inward data factors of FIG. 2 are exemplary only, and that fewer, additional and/or alternative types of inward data factors may be similarly monitored and analyzed by data analysis logic 106 in other embodiments.

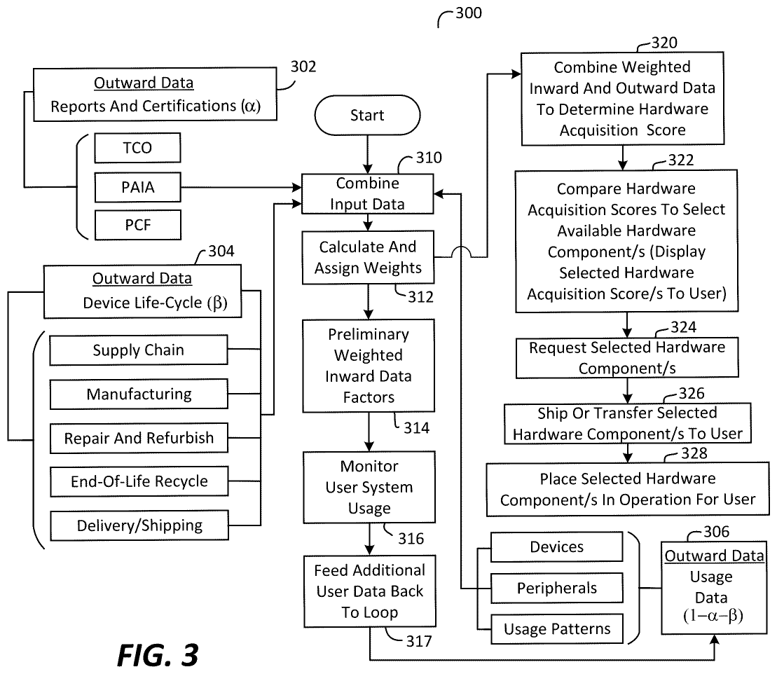

In one embodiment, inward data for a given user of local information handling system (e.g., such as described further herein in relation to block 306 of FIG. 3) may include inward data factors such as the user's usage patterns (e.g., such as battery utilization pattern, CPU resource utilization, graphics resource utilization, memory resource utilization, user application category utilization, etc.), and what the user's workspace setup or workspace configuration includes (e.g., characterized in terms of the number and identity of types of peripherals and other devices connected to the local information handling system 100, etc.).

In the determination of inward data factors, understanding a user's usage pattern may be used to predict the impact that a user will have on an acquired information handling system and hence the acquired information handling system's end of life after placed in operation. For example, a user that regularly uses an Adobe Photoshop application requires an information handling system having a high capability graphics card or high capability discrete graphics. Acquiring an information handling system that has limited graphics capability (e.g., no discrete graphics) will result in a poor user experience for the user and reduce the lifetime of the device. Taking into account the characteristics of the given user's workspace setup when calculating a hardware component acquisition score for the user ensures that a new information handling system is not acquired for the user that may appear on the surface to have the greatest sustainability in general, but that is actually not sufficient or useful to meet the user's workspace needs (e.g., because it lacks the minimum number of external hardware ports required for supporting the user's peripherals, etc.).

Examples of techniques that may be employed at least in part by data analysis logic 106 to gather and/or analyze inward data (e.g., such as collecting telemetry, etc.) include, but are not limited to, those techniques for monitoring and collecting telemetry described in U.S. patent application Ser. No. 18/130,860 filed Apr. 4, 2023, which is incorporated herein by reference in its entirety for all purposes. Examples of additional inward data factors that may be so collected include, but are not limited to, battery usage patterns (e.g., to predict battery swelling before it occurs), system memory data (e.g., to predict bad memory cells), etc. Examples of techniques that may be employed at least in part by data analysis logic 106 to gather and/or analyze additional inward data factors include, but are not limited to, techniques such as described in U.S. Pat. Nos. 9,146,855, 10,496,509, and 11,466,972 which are each incorporated herein by reference in entirety for all purposes, etc.

In one embodiment, data analysis logic 106 may obtain the identities of types of available information handling system hardware components 167 contained in manufacturer warehouses 166 from a respective manufacturer server 165 that is operated by the corresponding manufacturer of each given type of available information handling system hardware component 167. In one embodiment, data analysis logic 106 may obtain the identities of types of available information handling system hardware components 163 contained in internal inventory 162 from a programmable integrated circuit 169 of internal system inventory 162 and/or from administrative information handling system 161.

In one embodiment, data analysis logic 106 may obtain outward data for each given type of available information handling system hardware component (e.g., such as described further herein in relation to blocks 302 and 304 of FIG. 3) to determine how sustainable the given type of available information handling system hardware component is in terms of factors such as the carbon emission footprint, water usage, transportation, water usage, use of recycled materials, resource depletion and energy inputs of the manufacturing process and products used to manufacture the given type of available information handling system hardware component, as well as the operating energy efficiency, system end-of-life once placed in operation, human toxicity, ecotoxicity, of the given type of available information handling system hardware components when placed in use, etc.).

In one embodiment, some of the outward data used by data analysis logic 106 to determine outward data factors for a given type of available information handling system hardware component may be obtained by data analysis logic 106 (e.g., executing on local information handling system 100 and/or on administrative information handling system 161) for a type of given available information handling system hardware component 167 from a manufacturer server 165 that is operated by the corresponding manufacturer of the given type of available information handling system hardware component 167. In one embodiment, data analysis logic 106 may use natural language processing (NLP) to parse through documents to get manufacturer's published information, e.g., made available on their respective manufacturer servers 165.

Examples of outward data that may be obtained from a manufacturer server 165 by data analysis logic 106 to determine outward data factors for a given type of available information handling system hardware component 167 includes, but is not limited to, outward data factors contained in information or data made available (e.g., published) by the manufacturer of the given type of available information handling system hardware component 167 that is created according to standards like Swedish Confederation of Professional Employees (TCO) certification (toxicity), Product Attribute to Impact Algorithm (PAIA), and Product Carbon Footprint (PCF) reports and which provide an initial assessment into general sustainability characteristics (factors) of the given type of available information handling system hardware component 167. Other information that may be obtained by data analysis logic 106 for a given type of available information handling system hardware component 167 from a manufacturer server 165 that is operated by the corresponding manufacturer of the given type of available information handling system hardware component 167 includes, but is not limited to, outward data factors such as greenhouse gas (GHG) emissions, Leadership in Energy and Environmental Design (LEED) Certification, etc.

In one embodiment, data analysis logic 106 may leverage methodology used by a PAIA calculation and expand it to add additional outward data factors obtained from a manufacturer server 165 (or other information source) across external network 164 for each of different given types of available information handling system hardware components 167. For example, system manufacturing is often the most resource-intensive aspect of a type of available information handling system hardware component 167, and involves many manufacturing factors which may not be incorporated into a PAIA calculation including, but not limited to, use of recycled material, use of ocean bound plastics, water usage during system manufacturing, electricity requirement during system manufacturing, use of recycled aluminum, use of vegan leather, amount and type of system packaging materials, etc. These additional manufacturing factors may be additionally used in one embodiment as outward data factors for each of the different given types of available information handling system hardware components 167. Other such additional outward data factors which may not be incorporated into a PAIA calculation relate to environmental effects of the life cycle of a type of available information handling system hardware component 167, such as supply chain management, energy and type of material used in manufacturing, end-user delivery (shipping), durability and life expectancy, repair and refurbishment capability, end-of-life recycling potential, etc.

Another example of additional outward data factors which may not be incorporated into a PAIA calculation is repair and refurbish capability characteristics of a given type of available information handling system hardware component 167. In this regard, types of available information handling system hardware components 167 that are easy to repair and refurbish achieve reduced waste and have a better environmental impact and longer life span. Vendor association is also an example of such additional factors that plays a major role in defining sustainability of a given type of available information handling system hardware component 167.

Once inward data factors been determined for a given user of a given local information handling system 100, and outward data factors have been determined for each of multiple types of available information handling system hardware components 167, then these determined inward data factors are combined with the outward data factors of each of multiple types of available information handling system hardware components 167 to determine a single hardware component acquisition score (e.g., such as described further herein in relation to block 320 of FIG. 3) for each of the multiple different types of available information handling system hardware components that may be potentially acquired for the given user of local information handling system 100 from internal system inventory 162 and/or manufacturer inventories maintained in manufacturer warehouse and shipping facilities 166.

FIG. 3 illustrates one exemplary embodiment that may be implemented to determine the single hardware component acquisition score corresponding to the given user of a current given local information handling system 100 for each of multiple types of available information handling system hardware components 167, and to use these hardware component acquisition scores for the multiple types of available information handling system hardware components 167 to select and then acquire a given one or more of these multiple types of available information handling system hardware components 167 that have the highest hardware component acquisition score for the given user, i.e., to replace the given local information handling system. Although described in relation to types of different types of available information handling system hardware components 167 of different manufacturer's warehouses 166, the same methodology may be similarly implemented to compare, identify, and then acquire a given one or more of multiple types of available information handling system hardware components 163 contained in internal system inventory 162.

Methodology 300 of FIG. 3 begins with block 310, where inward data factors for a given user of local information handling system 100 is combined by data analysis logic 106 with outward data factors for a given type of the available information handling system hardware components 167. In one exemplary embodiment, methodology 300 may be initiated upon request entered to data analysis logic 106 by a given human user of a given local information handling system 100 or by a human ITDM user of administrative information handling system 161, e.g., when the given user or the ITDM desires replacement of a particular existing current local information handling system 100 (in whole) or a fleet of multiple local information handling systems 100 to 100_{N} (in whole), and/or replacement or acquisition of one or more additional hardware components that are used with the existing current local information handling system 100 or with a fleet of multiple local information handling systems 100 to 100_{N}. In another exemplary embodiment, data analysis logic 106 may automatically and iteratively perform methodology 300 to monitor performance of local information handling system 100, and automatically initiate acquisition of one or more available information handling system hardware components 167 upon identification of a performance problem or need for a replacement of a current existing information handling system hardware component and/or a need for acquisition of an additional hardware component for use with the current existing local information handling system 100 (e.g., described further herein in relation to block 314).

As shown in FIG. 3, different types of outward data factors may be obtained (e.g., across external network 164 from a manufacturer server 165) for a given type of available information handling system hardware component 167, e.g., such as different manufacturer reports and certifications data or information (α) 302 and device or system life cycle data or information (β) 304 for the given type of available information handling system hardware component 167. Examples of such manufacturer reports and certifications data or information (α) 302 include, but are not limited to, Swedish Confederation of Professional Employees (TCO) certification information, Product Attribute to Impact Algorithm (PAIA) information, Product Carbon Footprint (PCF) report information, greenhouse gas (GHG) emission information, or Leadership in Energy and Environmental Design (LEED) Certification. Examples of such device or system life cycle data or information (0β 304 include, but are not limited to, supply chain management information, energy and type of material used in manufacturing information, end-user delivery information, durability and life expectancy information, repair and refurbishment capability information, and end-of-life recycling potential information.

As further shown in FIG. 3, input data in block 310 may also include inward data factors (1-α-β) 306 in the form of usage data (e.g., device usage, peripheral usage, usage patterns, etc.) for the given user of the given local information handling system 100, e.g., from BIOS and/or OS telemetry data provided via usage data collection logic 102 by one or more telemetry utilities or other executing logic 109 (e.g., Microsoft Task Manager utility of Windows OS, BIOS driver, etc.) and/or other suitable user input and resource-monitoring software of firmware executing on host programmable integrated circuit 110. It will be understood that the particular combination of outward and inward data factors 302, 304 and 306 that is illustrated in FIG. 3 is exemplary only, and that additional, fewer, and/or alternative inward data factors and/or outward data factors may be employed in other embodiments.

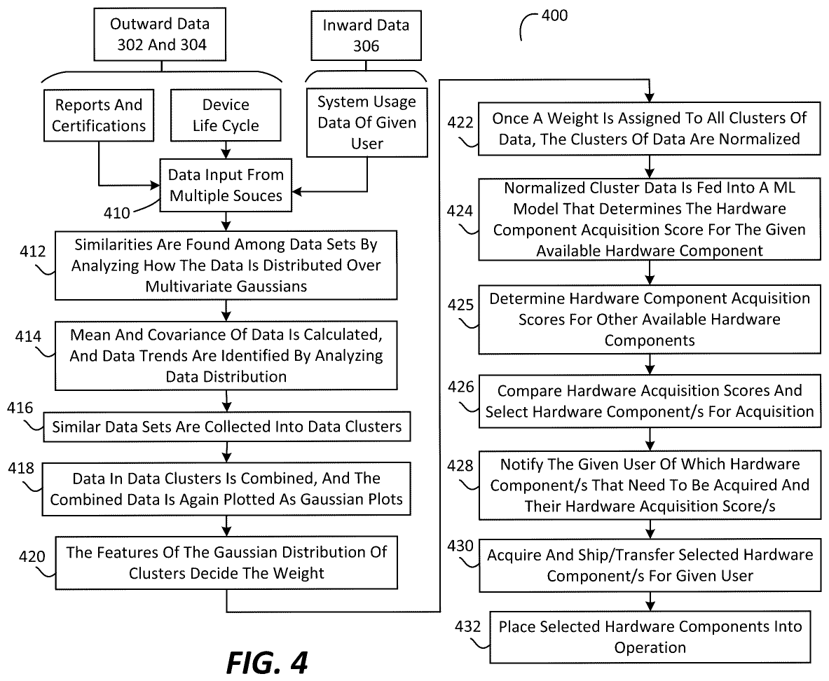

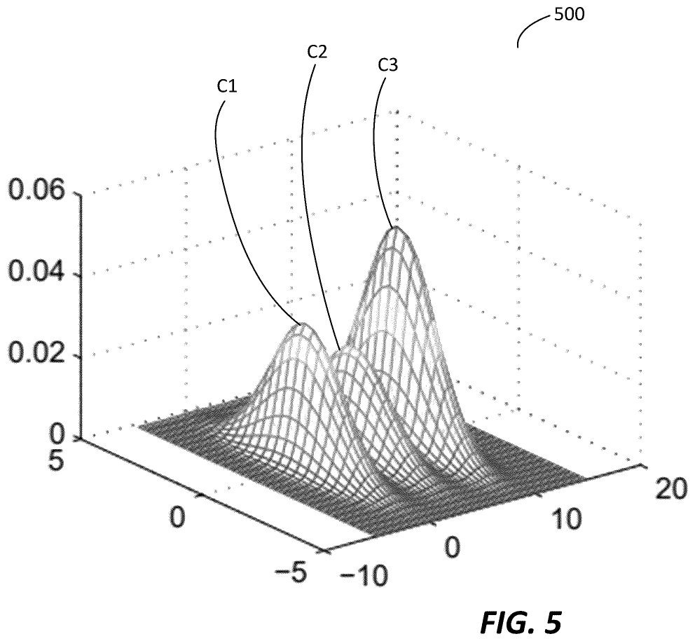

Next, in block 312 a weight for each of the outward data factors (302, 304) of the given type of available information handling system hardware component 167 and the inward data factors 306 of block 310 is determined and assigned by data analysis logic 106. One example of an exemplary methodology for calculating each of these weights is illustrated and described further herein in relation to FIGS. 4 and 5 herein.

Next, in block 314, data analysis logic 106 multiplies each of the inward data factors 306 for a given user of a current existing local information handling system 100 by its respective assigned weight (that was determined in current iteration of block 312) to calculate a set of respective preliminary weighted inward data factors. These preliminary weighted inward data factors may be updated with each iteration of methodology 300 and, in one optional embodiment, may be monitored by data analysis logic 106 to identify a performance problem or need for a replacement of one or more current existing information handling system hardware components and/or a need for acquisition of one or more additional hardware components for use with the current existing local information handling system 100 (e.g., as illustrated herein in relation to the hypothetical examples further herein).

Next, in block 316, additional user inward data of local information handling system 100 is continuously and iteratively monitored by data analysis logic 106 (e.g., from BIOS and/or OS telemetry data provided by one or more telemetry utilities or other executing logic 109 as previously described), and fed back in block 317 as shown in FIG. 3 so as to continuously update over time the inward data factors (e.g., device usage, peripheral usage, usage patterns, etc.) of user usage data (1-α-β) 306. Examples of inward data usage pattern factors include, but are not limited to, battery utilization, CPU resource utilization, graphics utilization, user application utilization, etc. After each iteration of block 316, updated usage data (1-α-β) 306 is then iteratively provided to data analysis logic 106 as inward data factors for combination with outward data factors in block 310 as previously described.

Returning to block 312, methodology 300 proceeds from block 312 to block 320 (e.g., upon a request input by local user to local information handling system 100, a request input by a ITDM user to administrative information handling system 161, or an automatically upon identification in block 314 of a performance problem or need for a replacement of one or more current existing information handling system hardware components and/or a need for acquisition of one or more additional hardware components for use with the current existing local information handling system 100). In block 320, data analysis logic 106 multiplies each of the outward data factors (302, 304) for the given type of available information handling system hardware component 167 with its respective assigned weight (that was determined in block 312) to calculate a respective weighted outward data factor. Also in block 320, data analysis logic 106 multiplies each of the inward data factors 306 by its respective assigned weight (that was determined in block 312) to calculate a respective weighted inward data factor. All of the resulting weighted outward data factors and weighted inward data factors are then combined by data analysis logic 106 in block 320 to calculate a hardware component acquisition score for the given type of available information handling system hardware component 167.

Data analysis logic 106 may perform blocks 310 to 320 of methodology 300 in similar manner by combining respective outward data factors (302, 304) for other different types of available information handling system hardware components 167 with the inward data factors 306 of the given user of the given local information handling system 100 to determine a respective hardware component acquisition score for each of the other different types of available information handling system hardware components 167.

Next, in block 322, hardware component acquisition scores calculated in block 320 for the multiple different types of available information handling system hardware components 167 are compared to each other by data analysis logic 106 to select the type of available information handling system hardware component 167 having the highest hardware component acquisition score among the hardware component acquisition scores of all the types of available information handling system hardware components 167. Acquisition and notification logic 108 executing on host programmable integrated circuit 110 may then optionally display the identity of this selected type of available information handling system hardware component 167 to the given local user on a display device (e.g., 140, 141a or 141b) of local information handling system 100, and/or to an ITDM user on a display device of administrative information handling system 161. Acquisition and notification logic 108 may also display a notification that this selected type of available information handling system hardware component 167 will be automatically acquired to replace the current local information handling system 100 for the given local user.

Next in block 324, acquisition and notification logic 108 may automatically acquire the selected type of available information handling system hardware component 167 from its respective given manufacturer for the given local user, e.g., by creating and transmitting a request for shipment to the respective given manufacturer server 165 that administers the particular manufacturer warehouse 166 or other existing inventory that contains the selected type of available information handling system hardware component 167. This request for shipment (e.g., such as purchase order or other message) may specify request for delivery of one unit of the selected type of available information handling system hardware component 167 to the physical address or physical location of the given local system user of the current local information handling system 100. In response to the request for shipment of block 324, the respective given manufacturer server 165 receiving the request of block 324 may implement transfer of the selected type of available information handling system hardware component 167 to the shipping physical address or physical location of the given local system user of the current local information handling system 100, e.g., by generating a transfer label (e.g., including transfer barcode) to initiate transfer of the selected type of available information handling system hardware component 167 from the given manufacturer's warehouse 166 to the given user of local information handling system 100 by automated shipping operations (e.g., performed by deploying a shipping robot or drone carrying the selected type of available information handling system hardware component 167 to the physical location/address of the given user of local information handling system 100) and/or by manufacturer shipping personnel via freight vehicles or other shipping method.

In one optional embodiment, a system manufacture request for the selected type of available information handling system hardware component 167 may be alternatively and/or additionally automatically generated by the respective manufacturer server 165 and sent via network to a programmable integrated circuit of a corresponding manufacturing facility of the given manufacturer of the selected type of available information handling system hardware component 167, e.g., in the case that no existing manufactured unit of the selected type of available information handling system hardware component 167 currently physically exists within the given manufacturer's warehouse 166. In such an alternative embodiment, the identity of number and types of information handling systems 167 that currently physical exist (and are available) in the given manufacturer's warehouse 166 may be determined, e.g., by automatically or manually reading barcodes or radio frequency identification (RFID) tags of all the available systems 167 that are currently physically present within the warehouse/s of the internal system inventory 166.

In an alternative embodiment of block 324, acquisition and notification logic 108 may automatically acquire for the given user the selected type of available information handling system hardware component 163 from internal system inventory 162, e.g., by creating and transmitting a request for transfer from administrative information handling system 161 to a programmable integrated circuit 169 of internal system inventory 162 that maintains the different types of available information handling system hardware components 163. This request for transfer may specify transfer of one unit of the selected type of available information handling system hardware component 163 to the physical location or physical address of the given local system user of the current local information handling system 100. In a further alternative embodiment, local user or an ITDM user may in block 324 cause transmission of the request for transfer to a programmable integrated circuit 169 of internal system inventory 162 or the request for shipment to a respective given manufacturer server 165 that administers the particular manufacturer warehouse 166 for the selected type of available information handling system hardware component 163 or 167 (as the case may be), e.g., in response to display of the identity of this selected type of available information handling system hardware component 167 described in block 322.

In response to the request for transfer of block 324, the programmable integrated circuit 169 of internal system inventory 162 receiving the request of block 324 may automatically implement physical transfer of the selected type of available information handling system hardware component 163 to the internal physical address or internal physical location of the given local system user of the current local information handling system 100 (e.g., by generating a transfer label including transfer barcode) by initiating transfer of the selected type of available information handling system hardware component 163 in block 326 to the given user of local information handling system 100 by automated shipping operations (e.g., performed by automatically deploying a shipping robot or drone carrying the selected type of available information handling system hardware component 163 to the internal physical location/address of the given user of local information handling system 100) and/or by system transfer internal personnel. In such an alternative embodiment, the identity of number and types of information handling systems 163 that currently physical exist (and are available) in internal system inventory 162 may be determined, e.g., by automatically or manually reading barcodes or radio frequency identification (RFID) tags of all the available systems 163 that are currently physically present within the warehouse/s of the internal system inventory 162.

In one optional embodiment of block 322, acquisition and notification logic 108 may ask for local user and/or ITDM user confirmation prior to acquiring the selected type of available information handling system hardware component 167 or 163 from its respective manufacturer or internal system inventory 162 for the given local user. For example, acquisition and notification logic 108 may display a graphical user interface (GUI) confirmation button and may require local user and/or ITDM user input (e.g., via selection of a GUI “OK” button or other designated user input) to confirm or otherwise approve the action of block 324 to acquire a unit of the selected type of available information handling system hardware component 167 or 163 from its respective manufacturer for the given local user.

In block 326, a unit of the selected type of available information handling system hardware component 167 or 163 is shipped or transferred to the specified physical address or physical location of the given local system user of the current local information handling system 100, as per the request of block 324. In block 328, the shipped unit of the selected type of available information handling system hardware component 167 from block 326 is received by the given local user of the given local information handling system 100, and is placed into operation in the place of the given local information handling system 100, e.g., by the given user or by information technology (IT) technical support personnel.

Although described above in relation to acquisition of available information handling system hardware components 167 or 163, it will be understand that methodology 300 may be further implemented in block 326 to automatically initiate and/or accomplish return of one or more currently existing information handling system hardware components used with local information handling system 100 (or current existing local information handing system 100 itself) when data analysis logic 106 determines (e.g., in block 314) that such components are not needed by (e.g., are not used by or have never been used by) the given user of the current existing local information handling system 100, e.g., such as illustrated in relation to Hypothetical Example 1 herein. Such automatic return may include, for example, executing acquisition and notification logic 108 to display a corresponding component return notification (e.g., optionally with instruction for returning/shipping the returned component/s) on display device 140 to the given user and/or by initiating automatic return shipping operation (e.g., performed by deploying a shipping robot or drone to the physical location/address of the given user of local information handling system 100), for example, to a inventory of information handling system hardware components designated by acquisition and notification logic 108 (e.g., such as internal system inventory 162 or a designated manufacturer inventory maintained in a manufacturer warehouse and shipping facility 166).

FIG. 4 illustrates one exemplary embodiment a methodology 400 that may be performed by data analysis logic 106 using unsupervised machine learning for each of the different types of available information handling system hardware components 167 or 163 to calculate and assign a weight to each of the outward data factors (302, 304) of each of the different types of available information handling system hardware components 167 or 163 and to each of the inward data factors 306, and to then determine a hardware component acquisition score for each of the different types of available information handling system hardware components 167 or 163. In one embodiment, assignment of weights to each of the data factors may be employed where the combination of outward data factors and inward data factors data is high dimensional (e.g., because it includes a combination of manufacturer data, user data and workspace data) and/or when a target hardware component acquisition score is not initially defined.

As shown in FIG. 4, methodology 400 begins in block 410 where the outward data factors (302, 304) for a given type of available information handling system hardware component 167 or 163 and the inward data factors 306 for the given user of local information handling system 100 are combined. Next, in block 412, similarities are found among datasets of this combined data by analyzing how the data is distributed over multivariate Gaussian plots. In this regard, each dataset of block 412 may contain data in any suitable format (e.g., such as words, sentences, numbers, images, etc.).

Next, in block 414, mean and covariance of the data from block 412 is calculated, and data trends from the datasets are identified based on the data distribution. In block 416, similar datasets are collected into data clusters (or groups of similar data). In one embodiment, of blocks 410 to 416, data may be converted into machine readable format (e.g., using natural language processing (NLP)), standardized, preprocessed, and then fed into a machine learning model for clustering (i.e., grouping similar-looking data into clusters) using an unsupervised machine learning technique.

Next, in block 418, data in the data clusters of block 416 is combined, and the combined data is plotted into gaussian plots that include a respective plot for each data cluster, e.g., as shown in the simplified example embodiment of FIG. 5. Then, in block 420, features of the gaussian distribution of data clusters from block 418 are used to determine and assign the overall weight of each of the data clusters of the combined data for a given type of available information handling system hardware component 167 or 163 of the current iteration of methodology 400.

In one embodiment, a Bayesian Shrinkage model using an iterative expectation-maximization (EM) may be employed to assign weights to a training dataset in multiple dimensions. This Bayesian Shrinkage methodology may be used to indicate which variables need to be pruned for effective clustering, variable selection, and assigning weights for the use case to normalize the probability distribution. In this regard, the Bayesian Shrinkage method may be extended from dealing with two-dimensional data in classification and clustering problems to handle multi-dimensional data, i.e., to assign weights when data is coming from multiple different sources. In one embodiment, the Bayesian Shrinkage method may be so used to discover the right set for key performance indicators (KPIs) used for calculating a hardware component acquisition score that is personalized to a given user.

In one embodiment, Bayesian Shrinkage methodology may be employed to assign weights to data factors using unsupervised machine learning to predict output. In such an embodiment, the Bayesian Shrinkage method may be used to first divide the combined data (i.e., combined inward data factors and outward data factors) into groups of similar featured data (i.e., data clusters). The Bayesian Shrinkage method may then be implemented using multivariate Gaussian distribution to label the different clusters, and using plots (e.g., together with additional inward data and/or outward data obtained in successive iterations) to plot Gaussian distribution plots and assign weights to the different clusters. These assigned weights may then be used to determine a hardware component acquisition score, e.g., by re-checking by cross-validation to finalize the weights and then determining a hardware component acquisition score for each given type of available information handling system hardware component 167 or 163.

For example, in the hypothetical Gaussian plot 500 of FIG. 5, three clusters of data have been plotted in the x-y-z axes, and are respectively labelled in FIG. 5 as data clusters C1, C2, and C3. As an example only for illustration, data cluster C1 may contain outward data corresponding to manufacturing and supply chain data; data cluster C2 may contain outward data corresponding to certification and PAIA data; and data cluster C3 may contain inward data corresponding to user CPU resource usage, graphics (GFX) resource usage, and system memory usage data. In one embodiment the weight of each data cluster (e.g., of FIG. 5) may be calculated from the respective x, y and z values taken at the y-axis peak of each data cluster using the following equation:

$$Weight = \frac{1}{\sqrt{{x}^{2} + {y}^{2} + {z}^{2}}}$$

In the example of FIG. 5, data cluster C3 has a higher assigned y-axis weight contribution of 150 as compared to data clusters C1 and C2, and data cluster C2 has the lowest assigned y-axis weight contribution of 50 i.e., the cluster having the greatest y-axis peak has the highest assigned weight contribution. In FIG. 5, data cluster C3 has an assigned y-axis weight contribution of 150.

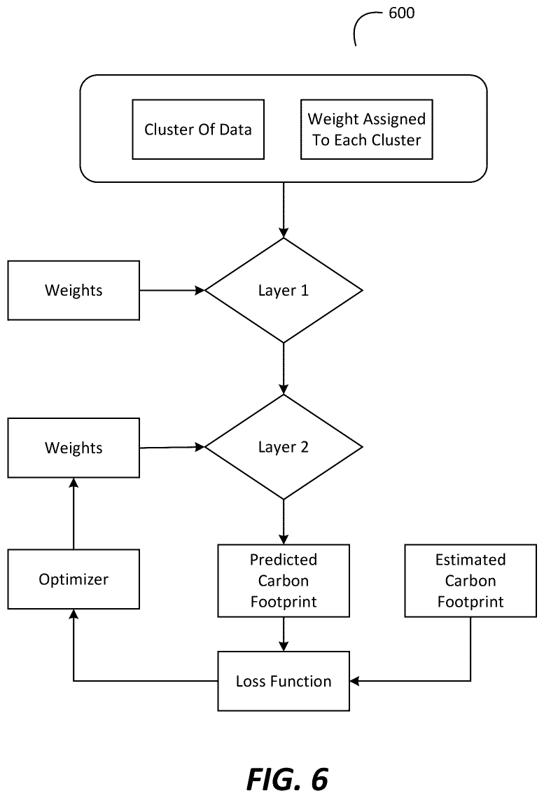

Next, in block 422, data analysis logic 106 normalizes the data clusters of block 416, e.g., by using Z-score to normalize each data point to the standard deviation. In block 424, data of the normalized datasets (clusters) of block 422 are then fed into a machine learning (ML) model (e.g., such as TensorFlow) of data analysis logic 106 that determines the hardware component acquisition score for the given available information handling system hardware component 167 or 163 of the current iteration of methodology 400, e.g., as illustrated in the illustrative flowchart of example machine learning analysis 600 of FIG. 6. Blocks 410 to 422 of methodology 400 are iteratively repeated for other multiple types of available information handling system hardware components 167 or 163 in block 425 to determine a respective hardware component acquisition score for each of these other types of available information handling system hardware components 167 or 163, e.g., similarly as previously described in relation to blocks 310 to 320 of FIG. 3.

Next, in block 426, data analysis logic 106 compares the hardware component acquisition scores determined in block 424 for each of the multiple different types of available information handling system hardware components 167 or 163 to determine and select the available type of information handling system hardware component 167 or 163 that has the greatest hardware component acquisition score of all the multiple different types of available information handling system hardware components 167 or 163 that have been analyzed using blocks 410 to 422 of methodology 400. Also in block 426, data analysis logic 106 feeds the identity of the selected type of available information handling system hardware component 167 or 163 (e.g., manufacturer and model number, or other suitable identifying information for the selected system) to acquisition and notification logic 108.

Next, in block 428, acquisition and notification logic 108 notifies the ITDM of administrative information handling system 161 and/or the given user of the given local information handling system 100 of the selected type of available information handling system hardware component 167 or 163 that is to be acquired for the given local user to replace the given local information handling system 100. Acquisition and notification logic 108 also notifies the ITDM and/or the given local user of the determined hardware component acquisition score for the selected type of available information handling system hardware component 167 or 163 (e.g., optionally with the environmental impacts of the selected type of available information handling system hardware component 167 or 163). In one embodiment, blocks 426 and 428 may be similarly performed as described in relation to block 322 of FIG. 3. Then, blocks 430 and 432 may be similarly performed as described in relation to blocks 324 to 328 of FIG. 3.

It will understood that the particular combination of steps of FIGS. 3 and 4 are exemplary only, and that other combinations of additional, fewer, and/or alternative steps may be employed to select and acquire available information handling system hardware components based on inward data and outward data.

The following non-limiting hypothetical examples are provided to illustrate implementation and advantages of the disclosed systems and methods.

### Hypothetical Example 1

Assume multiple human fleet users operate respective local information handling systems 100 in an ITDM fleet (e.g., that are each coupled to an administrative information handling system 161 by an internal network 160) using particular devices and peripherals in a certain way in each given user's workspace on their respective local information handling system 100. Using the methodologies of FIGS. 3 and/or 4, data analysis logic 106 executing on administrative information handling system 161 collects inward data 306 for the multiple different users that includes each user's usage data (e.g., including the identity of the particular devices and peripherals used by each given user with their respective local information handling system 100 and the way in which these particular devices and peripherals are used by each given user with their respective local information handling system 100). Data analysis logic 106 also collects outward data 302 and 304, e.g., from manufacturer servers 165.

Now assume a fleet wide policy is implemented by which all fleet users of the local information handling systems 100 in the ITDM fleet are provided with new peripheral components in the form of an external mouse and an external keyboard for use with their respective local information handling system 100. However, after this change (e.g., deployment) in the ITDM fleet peripheral components, the inward data 306 collected by data analysis logic 106 on system 161 indicates that a first portion of the multiple fleet users in the ITDM fleet never use (e.g., have never used) their provided external mouse and external keyboard, but that they use their respective local information handling system 100 to participate in conference calls across network 160 and/or network 164 for many hours in a day without using their provided external mouse and external keyboard.

Using the methodologies of FIGS. 3 and/or 4, data analysis logic 106 understands the inward data factors of each given user's peripheral component requirement (e.g. by analysis of the given user's inward data 306) as well as the outward data factors (e.g., such as carbon footprint) of available types of peripheral components in internal component inventory 162 (e.g., based on analysis of outward data 302 and 304). Based on the understanding of the inward data factors for each fleet user, data analysis logic 106 identifies that each user in the first portion of fleet users has a need or requirement for a particular category of information handling system hardware component, i.e., in this case a peripheral headphone component for use with their respective local information handling system 100 (e.g., to use for participation in conference calls). Also based on the understanding of the inward data factors for each fleet user, data analysis logic 106 identifies that each user in the first portion of fleet users has no need or requirement for the existing and not-used external mouse and external keyboard categories of information handling system hardware components that are currently deployed in operation with their respective local information handling system 100.

Based on the understanding of both the inward and outward data factors and the hardware component acquisition score determined for each fleet user, data analysis logic 106 responds to the deployment of the new external mouse and external keyboard peripheral components by automatically selecting a particular available type (e.g., manufacture and model number) of peripheral headphone component from the needed category of information handling system hardware component (i.e., in this case peripheral headphone component) that has been identified as being needed for each user in the first portion of fleet users, and acquisition and notification logic 108 automatically acquires the selected available headphone type from internal component inventory 162 for each user in the first portion of fleet users.

In this example, acquisition and notification logic 108 may also further automatically initiate and/or arrange for return of the not-needed external mouse and keyboard peripheral components from each of the users in the first portion of fleet users to a designated inventory of information handling system hardware components, and optionally providing of these returned external mouse and keyboard peripheral components to a second group of fleet users that data logic analysis logic 106 has determined use these peripheral components. This improves system operation for each of the local information handling systems 100 in the ITDM fleet, while at the same time improving individual fleet user experience (by providing these fleet users with the peripheral components that they actually need), and reducing overall expense paid for new peripheral devices.

For illustration, other example categories of information handling system hardware components include, but are not limited to, programmable integrated circuits, storage devices, memory devices, batteries, peripheral components, assembled information handling systems, etc. Each of these categories of information handling system hardware components may in turn include multiple different available types (e.g., different manufacturers and/or model numbers) of information handling system hardware components.

### Hypothetical Example 2

Assume a given user is unhappy with the performance of their personal local information handling system 100, and wants to replace it due to its poor performance. In this case, the given user's local information handling system 100 is configured as a notebook computer that is coupled to an external network 164. Due to their dissatisfaction with the performance of local information handling system 100, the given user provides a system analysis request via input devices 170 to request that data analysis logic 106 analyze acquisition of a new notebook computer to replace their existing notebook computer 100. In the meantime, using the methodologies of FIGS. 3 and/or 4, data analysis logic 106 has been previously executing on the given user's local information handling system 100 to collect inward data 306 for the given user that includes the user's usage data on local information handling system 100 (e.g., including battery resource utilization). Data analysis logic 106 also collects outward data 302 and 304, e.g., across external network 164 from manufacturer servers 165.

Data analysis logic 106 responds to the system analysis request received from the given user by using the methodologies of FIGS. 3 and/or 4 to analyze and understand the collected inward data factors that include the user's system resource needs (e.g., including notebook battery resources), as well as the collected outward data factors (e.g., device life cycle) of available types of system information handling system hardware components in manufacturers' warehouses 161 (e.g., based on analysis of outward data 302 and 304). Based on this understanding of the inward and outward factors and the hardware component acquisition scores determined therefrom for available information handling system hardware components, data analysis logic 106 determines that the given user does not need a new information handling system 100 to meet their system resource needs, but only needs to acquire a selected type of new battery component for their local information handling system 100, e.g., due to detected failure or degradation of the corresponding existing battery component currently installed in the given user's local information handling system 100. This is because data analysis logic 106 understands from the collected data that the given user predominantly uses local information handling system 100 in battery-only mode, which results in accelerated degradation of battery performance.

Data analysis logic 106 forwards this determination to acquisition and notification logic 108, which responds by notifying the given user that only the selected type of new notebook battery component is required, and also by automatically acquiring the selected type of new battery component for the given user's notebook computer 100, e.g., by submitting a purchase order across external network 164 to the appropriate manufacturer server 165 that manages a warehouse 166 that contains an inventory that includes the selected type of new battery component to cause shipment of the selected type of new battery component from the manufacture's warehouse 166 to the physical address of the given user of local information handling system notebook computer 100. This acquisition of a new battery component improves system operation (e.g., user experience) of local information handling systems 100 for the given user (when it is installed and placed into operation in the given user's local information handling system 100), while at the same time saving the user money and reducing environmental impact by not needlessly purchasing an entire new notebook computer system for the given user.

It will be understood that one or more of the tasks, functions, or methodologies described herein (e.g., including those described herein for components 100, 101, 102, 103, 106, 108, 109, 110, 120, 130, 140, 141, 150, 159, 160, 161, 162, 164, 166, 164, 165, 167, 169, 171, 173, 175, 179, 180, 181, 190, etc.) may be implemented by circuitry and/or by a computer program of instructions (e.g., computer readable code such as firmware code or software code) embodied in a non-transitory tangible computer readable medium (e.g., optical disk, magnetic disk, non-volatile memory device, etc.), in which the computer program includes instructions that are configured when executed on a processing device in the form of a programmable integrated circuit (e.g., processor such as CPU, controller, microcontroller, microprocessor, ASIC, etc. or programmable logic device “PLD” such as FPGA, complex programmable logic device “CPLD”, etc.) to perform one or more steps of the methodologies disclosed herein. In one embodiment, a group of such processing devices may be selected from the group consisting of CPU, controller, microcontroller, microprocessor, FPGA, CPLD and ASIC. The computer program of instructions may include an ordered listing of executable instructions for implementing logical functions in an processing system or component thereof. The executable instructions may include a plurality of code segments operable to instruct components of an processing system to perform the methodologies disclosed herein.

It will also be understood that one or more steps of the present methodologies may be employed in one or more code segments of the computer program. For example, a code segment executed by the information handling system may include one or more steps of the disclosed methodologies. It will be understood that a processing device may be configured to execute or otherwise be programmed with software, firmware, logic, and/or other program instructions stored in one or more non-transitory tangible computer-readable mediums (e.g., data storage devices, flash memories, random update memories, read only memories, programmable memory devices, reprogrammable storage devices, hard drives, floppy disks, DVDs, CD-ROMs, and/or any other tangible data storage mediums) to perform the operations, tasks, functions, or actions described herein for the disclosed embodiments.

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touch screen and/or a video display. The information handling system may also include one or more buses operable to transmit communications between the various hardware components.

While the invention may be adaptable to various modifications and alternative forms, specific embodiments have been shown by way of example and described herein. However, it should be understood that the invention is not intended to be limited to the particular forms disclosed. Rather, the invention is to cover all modifications, equivalents, and alternatives falling within the spirit and scope of the invention as defined by the appended claims. Moreover, the different aspects of the disclosed systems and methods may be utilized in various combinations and/or independently. Thus the invention is not limited to only those combinations shown herein, but rather may include other combinations.

What is claimed is:

1. A method, comprising:
executing at least one programmable integrated circuit to:
obtain one or more inward data factors that include at least one of workspace configuration or one or more usage patterns for a given user of a local information handling system,
obtain one or more outward data factors for each of multiple different available information handling system hardware component types that are different from the local information handling system, the one or more outward data factors including at least one of device or system life cycle data, manufacturer report/s, or manufacturer certification/s for each of the multiple different available information handling system hardware component types,
combine the inward data factors with the outward data factors of each of the multiple different available information handling system hardware component types to determine a hardware component acquisition score for each of the multiple different available information handling system hardware component types,
compare the hardware component acquisition scores of the multiple different available information handling system hardware component types to each other, and
select a given one of the multiple different available information handling system hardware component types that has the highest hardware component acquisition score relative to all other of the multiple different available information handling system types; and
acquiring the selected given one of the multiple different available information handling system hardware component types for the given user of the local information handling system by physically transferring the selected given one of the multiple different available information handling system hardware component types to the given user of the local information handling system.

2. The method of claim 1, where the workspace configuration inward data factors comprise at least one of number or type of peripheral devices or other devices connected to the local information handling system; and where the usage pattern inward data factors comprise at least one of battery utilization pattern, central processing unit (CPU) resource utilization, graphics resource utilization, memory resource utilization, or user application utilization; and where the manufacturer reports and manufacturer certifications of the outward data factors comprise at least one of Swedish Confederation of Professional Employees (TCO) certification information, Product Attribute to Impact Algorithm (PAIA) information, Product Carbon Footprint (PCF) report information, greenhouse gas (GHG) emission information, or Leadership in Energy and Environmental Design (LEED) Certification; and where the device or system life cycle data of the outward data factors comprise at least one of supply chain management information, energy and type of material used in manufacturing information, end-user delivery information, durability and life expectancy information, repair and refurbishment capability information, or end-of-life recycling potential information.

3. The method of claim 1, further comprising placing the acquired given one of the multiple different available information handling system hardware component types into operation for the given user of the local information handling system.

4. The method of claim 1, further comprising executing the at least one programmable integrated circuit to obtain the one or more inward data factors by monitoring and gathering data regarding at least one of past workspace configuration or usage trends of the local information handling system for the given user of the local information handling system.

5. The method of claim 1, further comprising executing the at least one programmable integrated circuit to obtain the one or more outward data factors across a network from one or more remote information handling systems.

6. The method of claim 1, where the multiple different available information handling system hardware component types correspond to types of information handling system hardware components that are contained within an inventory of information handling system hardware components.

7. The method of claim 1, further comprising executing the at least one programmable integrated circuit to:
use unsupervised machine learning to determine and assign a weight for each of the outward data factors and the inward data factors of each of the multiple different available information handling system hardware component types, and to apply the assigned weight of each of the given outward data factors to the corresponding respective given outward data factor to determine a corresponding respective weighted outward data factor and apply the assigned weight of each of the given inward data factors to the corresponding respective given inward data factor to determine a corresponding respective weighted inward data factor; and
then use machine learning to determine the hardware component acquisition score for each given one of the multiple different available information handling system hardware component types from the determined weighted outward data factors and the determined weighted inward data factors of the respective given one of the multiple different available information handling system hardware component types.

8. The method of claim 1, further comprising executing the at least one programmable integrated circuit to display on a display device at least one of the identity of the selected given one of the multiple different available information handling system hardware component types, the hardware component acquisition score for each given one of the multiple different available information handling system hardware component types, or the hardware component acquisition score for only the selected given one of the multiple different available information handling system hardware component types.

9. The method of claim 1, where the acquiring the selected given one of the multiple different available information handling system hardware component types for the given user of the local information handling system comprises:
executing the at least one programmable integrated circuit to automatically transmit a transfer request across a network to a second programmable integrated circuit for physical transfer of the selected given one of the multiple different available information handling system hardware component types to a location of the given user of the local information handling system from an existing inventory that contains the selected given one of the multiple different available information handling system hardware component types; and
executing the second programmable integrated circuit to automatically respond to the transfer request by physically transferring the selected type of available information handling system hardware component to the location of the given user of the local information handling system.

10. The method of claim 1, where the at least one programmable integrated circuit is an integral component of the local information handling system.

11. The method of claim 1, where the at least one programmable integrated circuit is an integral component of an administrative information handling system that is coupled by a network to the local information handling system.

12. The method of claim 1, further comprising executing the at least one programmable integrated circuit to:
analyze the obtained inward data factors to identify a given category of information handling system hardware component that is needed by the given user of the local information handling system, and where each of the multiple different available information handling system hardware component types is included within the given category of information handling system hardware component; and
then perform the selecting of the given one of the multiple different available information handling system hardware component types by selecting the given one of the multiple different available information handling system hardware component types from the identified given category of information handling system hardware component that has the highest hardware component acquisition score relative to all other of the multiple different available information handling system types included within the identified given category of information handling system hardware component.

13. The method of claim 1, further comprising executing the at least one programmable integrated circuit to:
analyze the obtained inward data factors to identify at least one existing information handling system hardware component that is currently deployed for use with the local information handling system that is not used by the given user of the local information handling system; and
then automatically initiate return of the existing information handling system hardware component to an inventory of information handling system hardware components.

14. An information handling system, comprising at least one programmable integrated circuit that is programmed to:
obtain one or more inward data factors that include at least one of workspace configuration or one or more usage patterns for a given user of a local information handling system;
obtain one or more outward data factors for each of multiple different available information handling system hardware component types that are different from the local information handling system, the one or more outward data factors including at least one of device or system life cycle data, manufacturer report/s, or manufacturer certification/s for each of the multiple different available information handling system hardware component types;
combine the inward data factors with the outward data factors of each of the multiple different available information handling system hardware component types to determine a hardware component acquisition score for each of the multiple different available information handling system hardware component types;
compare the hardware component acquisition scores of the multiple different available information handling system hardware component types to each other;
select a given one of the multiple different available information handling system hardware component types that has the highest hardware component acquisition score relative to all other of the multiple different available information handling system types; and
acquire the selected given one of the multiple different available information handling system hardware component types for the given user of the local information handling system by requesting physical transfer of the selected given one of the multiple different available information handling system hardware component types to the given user of the local information handling system.

15. The information handling system of claim 14, where the workspace configuration inward data factors comprise at least one of number or type of peripheral devices or other devices connected to the local information handling system; and where the usage pattern inward data factors comprise at least one of battery utilization pattern, central processing unit (CPU) resource utilization, graphics resource utilization, memory resource utilization, or user application utilization; and where the manufacturer reports and manufacturer certifications of the outward data factors comprise at least one of Swedish Confederation of Professional Employees (TCO) certification information, Product Attribute to Impact Algorithm (PAIA) information, Product Carbon Footprint (PCF) report information, greenhouse gas (GHG) emission information, or Leadership in Energy and Environmental Design (LEED) Certification; and where the device or system life cycle data of the outward data factors comprise at least one of supply chain management information, energy and type of material used in manufacturing information, end-user delivery information, durability and life expectancy information, repair and refurbishment capability information, or end-of-life recycling potential information.

16. The information handling system of claim 14, where the at least one programmable integrated circuit is programmed to obtain the one or more inward data factors by monitoring and gathering data regarding at least one of past workspace configuration or usage trends of the local information handling system for the given user of the local information handling system.

17. The information handling system of claim 14, where the at least one programmable integrated circuit is programmed to obtain the one or more outward data factors across a network from one or more remote information handling systems.

18. The information handling system of claim 14, where the multiple different available information handling system hardware component types correspond to types of information handling system hardware components that are contained within an inventory of information handling system hardware components.

19. The information handling system of claim 14, where the at least one programmable integrated circuit is programmed to:
use unsupervised machine learning to determine and assign a weight for each of the outward data factors and the inward data factors of each of the multiple different available information handling system hardware component types, and to apply the assigned weight of each of the given outward data factors to the corresponding respective given outward data factor to determine a corresponding respective weighted outward data factor and apply the assigned weight of each of the given inward data factors to the corresponding respective given inward data factor to determine a corresponding respective weighted inward data factor; and
then use machine learning to determine the hardware component acquisition score for each given one of the multiple different available information handling system hardware component types from the determined weighted outward data factors and the determined weighted inward data factors of the respective given one of the multiple different available information handling system hardware component types.

20. The information handling system of claim 14, where the at least one programmable integrated circuit is programmed to display on a display device at least one of the identity of the selected given one of the multiple different available information handling system hardware component types, the hardware component acquisition score for each given one of the multiple different available information handling system hardware component types, or the hardware component acquisition score for only the selected given one of the multiple different available information handling system hardware component types.

21. The information handling system of claim 14, where at least one programmable integrated circuit that is programmed to:
automatically transmit a transfer request across a network to a second programmable integrated circuit for physical transfer of the selected given one of the multiple different available information handling system hardware component types to a location of the given user of the local information handling system from an existing inventory that contains the selected given one of the multiple different available information handling system hardware component types; and
executing the second programmable integrated circuit to automatically respond to the transfer request by physically transferring the selected type of available information handling system hardware component to the location of the given user of the local information handling system.

22. The information handling system of claim 14, where the information handling system is the local information handling system; and where the at least one programmable integrated circuit is an integral component of the local information handling system.

23. The information handling system of claim 14, where the at least one programmable integrated circuit is an integral component of an administrative information handling system that is coupled by a network to the local information handling system.
